(19) United States
(12) Patent Application Publication
(10) Pub. No.: US 2017/0102957 A1
(43) Pub. Date: Apr. 13, 2017

(54) System and Method for Trusted Operability When Moving Between Network Functions Virtualization States

(71) Applicant: Sprint Communications Company L.P., Overland Park, KS (US)

(72) Inventors: Ronald R. Marquardt, Woodinville, WA (US); Lyle W. Paczkowski, Mission Hills, KS (US); Arun Rajagopal, Leawood, KS (US)

(21) Appl. No.: 14/879,327

(22) Filed: Oct. 9, 2015

(51) Int. Cl. G06F 9/455; H04L 29/08

(52) U.S. Cl. CPC G06F 9/45558; H04L 67/32; G06F 2009/45595; G06F 2009/45587; G06F 2009/45583

(57) ABSTRACT

A method of establishing trusted operability between virtualized states of a Network Functions Virtualization (NFV) system providing a network service and operating in a virtual computing environment is disclosed. The method comprises receiving, by a physical server, a request to execute a trusted process, wherein the physical server comprises a processor with at least one core processing unit. The method further comprises assigning, by a trusted hypervisor, the execution of the trusted process to a first virtual server on a first core processing unit, dedicating physical portions of cache, memory, and disk storage to the first core processing unit; and executing the trusted process. The method further comprises receiving, by the physical server, a request to execute an untrusted process and assigning, by the trusted hypervisor, the execution of the untrusted process to a second virtual server on a second core processing unit, and restricting access to the trusted process.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

As proprietary hardware appliances used on network platforms have grown increasingly complex and rapidly reach the end of their life-cycle, network providers have turned to the use of network architecture called Network Functions Virtualization (“NFV”). NFV consolidates many, if not all, network functions and virtualizes those functions as software applications, run on industry standard high volume servers, switches and storage. However, the technical challenge remains of ensuring the security of data in an NFV environment as it is transferred between multiple users, applications, servers, and/or networks with different security protocols.

### SUMMARY

In an embodiment, a method of establishing trusted operability between virtualized states of a Network Functions Virtualization (NFV) system providing a network service and operating in a virtual computing environment is disclosed. The method comprises receiving, by a physical server operating in a virtual computing environment and associated with an NFV network, a request to execute a trusted process, wherein the physical server comprises a processor with at least one core processing unit. The method further comprises assigning, by a trusted hypervisor, the execution of the trusted process to a first virtual server, wherein the trusted hypervisor is executing on the physical server, is programmed to boot from a trusted state, and is configured to provide trusted operability using software assisted security. The method further comprises assigning, by the trusted hypervisor, the first virtual server to execute the trusted process on a first core processing unit; dedicating, by the trusted hypervisor, physical portions of cache, memory, and disk storage to the first core processing unit executing the trusted process; and executing, by the first core processing unit, the trusted process. The method further comprises receiving, by the physical server operating in a virtual computing environment and associated with an NFV network, a request to execute an untrusted process; assigning, by the trusted hypervisor, the untrusted process to execute on a second virtual server, wherein the second virtual server is different than the first virtual server executing the trusted process; assigning, by the trusted hypervisor, the second virtual server to execute the untrusted process on a second core processing unit, wherein the second core processing unit is different than the first core processing unit that is executing the trusted process; and executing the untrusted process on the second core processing unit. The method further comprises restricting, by the trusted hypervisor, access to the trusted process executing on the first virtual server.

In an embodiment, a system for establishing trusted operability between virtualized states of a Network Functions Virtualization (NFV) system providing a network service and operating in a virtual computing environment is disclosed. The system comprises a physical server operating in a virtual computing environment and associated with an NFV network; a processor located on the physical server, comprising at least one core processing unit, wherein the processor is configured to execute a trusted process on a dedicated core processing unit; a cache dedicated to the core processing unit; a memory dedicated to the core processing unit; and a disk storage dedicated to the core processing unit. The system further comprises a trusted hypervisor, executing on the physical server, wherein the trusted hypervisor is programmed to boot from a trusted state, is configured to provide trusted operability using software assisted security, is configured to assign trusted processes to a dedicated core processing unit, and wherein the trusted hypervisor is configured to monitor and restrict software and hardware access to the trusted processes executing on the dedicated core processing unit.

In an embodiment, a system for establishing trusted operability between virtualized states of a Network Functions Virtualization (NFV) system providing a network service and operating in a virtual computing environment is disclosed. The system comprises a physical server operating in a virtual computing environment and associated with an NFV network; a processor located on the physical server, comprising one or more core processing units, wherein the processor is configured to execute a trusted process on a dedicated core processing unit; a cache dedicated to the core processing unit; a memory dedicated to the core processing unit; and a disk storage dedicated to the core processing unit. The system further comprises a trusted hypervisor, executing on the physical server, wherein the trusted hypervisor is programmed to boot from a trusted state, is configured to provide trusted operability using software assisted security, is configured to assign trusted processes to a dedicated core processing unit, and wherein the trusted hypervisor is configured to monitor and restrict software and hardware access to the trusted processes executing on the dedicated core processing unit; and a second hypervisor, executing on the physical server, wherein the second hypervisor does not provide trusted operability;

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is an illustration of a system according to an embodiment of the disclosure.

FIG. 2A is an illustration of a component of a system according to an embodiment of the disclosure.

FIG. 2B is an illustration of a component of a system according to an embodiment of the disclosure.

FIG. 3 is a flowchart of a method according to an embodiment of the disclosure.

FIG. 4 is an illustration of an exemplary computer system suitable for implementing the several embodiments of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

Many network providers are utilizing a network architecture called Network Functions Virtualization (“NFV”) to run their networks. NFV operates by consolidating many, if not all, network functions and virtualizing those functions as software applications, run on general purpose computing hardware, such as industry standard high volume servers, switches and storage. At the core, an NFV platform or system utilizes Virtual Machines (“VM”) to run the network functions as software applications, called Virtualized Network Functions (“VNF”). NFV has many advantages, such as reduced equipment costs, reduced power consumption, decreased time to market for new services and applications, as well as the availability to use a single network for different applications and users.

In an NFV system, network functions may be factored into a plurality of common functions. Some of these common functions may be used by two or more network functions, for example a network attach common function may be used by both a mobility management entity (MME) network function and by a home subscriber server (HSS) network function. The factored and/or common functions may each execute in virtual servers. A management application or network function state control application orchestrates the delivery of the conventional network function by sending processing requests with parameters sequentially to the common functions. The management applications or network function state control applications may also execute in virtual servers. For further details about network function virtualization, see U.S. patent application Ser. No. 14/746,615, filed Jun. 23, 2015 entitled “Trusted Signaling in 3GPP Interfaces in a Network Function Virtualization Communication System,” by Lyle W. Paczkowski, et al., which is incorporated by reference herein in its entirety.

The consolidation of services and functions onto single servers in an NFV environment has created a greater ability to switch between virtualized states that execute virtualized functions or processes, i.e., “NFV states.” This greater connectivity raises security and allocation of resource issues. A significant security issue of the current NFV environment is that, in order to capitalize on limited hardware resources, virtualized functions are increasingly being allocated to hardware that does not have hardware assisted security, such as a hardware root of trust. Accordingly, networks operating in an NFV environment face increased vulnerability and limited space options for executing trusted processes.

For example, relevant to this disclosure, in a current NFV environment, when a processor switches from one virtualized state to another, it suspends the first process and permits the clock cycles to be used by another process. If the first virtualized state was operating in trust, the transition between the first virtualized state to the second virtualized state is a point where a security incursion can occur and where the NFV network is vulnerable to unwanted attack.

An allocation of resource issue in the current NFV environment is that hardware resources are often not allocated in a manner that permits the simultaneous operation of multiple virtualized or NFV states on a single processor. Currently, where a processor that is presently running an NFV state is requested to execute a second NFV state, then the processor will suspend operation of the current NFV state, store that state information in cache, and switch to the second NFV state. Further, the first NFV state is stored in a general cache environment where any process executing on the processor can access that cache. A hypervisor monitors and manages the transition between NFV states on the processor. The inability to run multiple processes simultaneously presents a limitation to operational speed, in addition to exposing a security risk at the boundaries of the transition between NFV states because any subsequent executing process can access the trusted NFV state operating that is suspended in general cache.

The present disclosure teaches systems and methods of establishing and maintaining trusted operability when communicating or transitioning between virtualized states of an NFV system executing on a single processor in an NFV environment.

Trusted operability is the capability of a virtual server, as provided by a hypervisor and the underlying physical server resources, operating in an NFV system to ensure that trusted portions of any particular process will be able to execute in a trusted and secure manner, free from incursion or exposure to nefarious and corrupting elements. In a non-virtualized network environment, network service providers are able to utilize hardware assisted security in order to ensure that sensitive data and/or applications are able to execute without exposure to unwanted programs or viruses. For a more thorough discussion of hardware assisted security, see U.S. patent application Ser. No. 13/532,588, filed Jun. 25, 2012, entitled “End-to-End Trusted Communications Infrastructure,” by Leo Michael McRoberts, et al., which is incorporated by reference herein in its entirety. The NFV environment poses particular challenges to executing applications in a trusted manner that maintains the security of the data and/or application. In the NFV environment, software applications, such as hypervisors, and widely used to execute common functions-which are thus “virtualized” over any hardware resource that is currently available. Hardware resources are specifically not allocated to any one function or application in an NFV environment. Further, cache, RAM memory, and disk storage are shared by multiple virtual servers and multiple processes. As a result of the free access to resources by multiple elements of a network, including virtual servers and processes executing on those virtual servers, executing a process in trust becomes difficult. Trusted operability is meant to overcome this security challenge by dedicating specific hardware elements to trusted processes and utilizing a hypervisor, operating in trust, which restricts the access to the dedicated hardware to only trusted processes.

In the present disclosure, trusted operability is accomplished by a combination of hardware resource allocation, selected and imposed on a physical server by a trusted hypervisor, as well as restriction of access by the trusted hypervisor to those allocated resources by untrusted virtual functions. A hypervisor is trusted when it is uncorrupted, programmed to boot from a trusted state, and boots from Read Only Memory (ROM) ensuring that the hypervisor cannot be reprogrammed or corrupted by exposure to untrusted processes or hardware.

In an embodiment, the trusted hypervisor monitors and manages a single physical server, which may contain multiple processors each containing multiple core units. The trusted hypervisor assigns no more than one virtual server to execute on a single core processing unit of each processor. Each core processing unit on the processor may have physically dedicated cache, assigned without hypervisor intervention, which serves only its assigned core processing unit. Although a virtual server may execute over several core processing units on a processor, a single core processing unit will not have more than one virtual server assigned to it to execute virtual functions. Trusted operability is imposed by the hypervisor when it assigns and dedicates a portion of RAM memory located on the physical server and a portion of hard disk storage in the NFV network to each core processing unit that executes trusted processes. The trusted hypervisor monitors the virtual server executing virtual functions on its assigned core processing unit of the processor and may also manage communication between trusted and untrusted processes on the processor. Alternatively, a physical server may have two hypervisors, one trusted and one untrusted. The trusted hypervisor monitors and manages only the trusted processes and the untrusted hypervisor monitors and manages the untrusted processes. Communication between trusted and untrusted processes would occur via communication between the trusted and untrusted hypervisors.

In an embodiment, trusted operability is established and maintained by the trusted hypervisor when it assigns and dedicates a portion of RAM memory and hard disk storage to each core processing unit executing trusted processes. The core processing unit now has trusted operability because it has physically dedicated cache, as well as dedicated memory and hard disk storage, along physical boundaries, to which the trusted hypervisor restricts access. The cache, RAM memory and hard disk storage may only be accessed by processes executing on the assigned core processing unit, which may execute some portions of its processes in trusted operability. The dedicated cache, RAM memory, and hard disk storage are therefore secure from intrusion from other processes executing on different core processing units, both trusted and untrusted. A trusted process executing on a core processing unit of a processor is able to access its dedicated cache, dedicated memory, and/or dedicated hard disk storage by utilizing memory registers, or trustlets, which track the transaction path of the executing process in cache and memory.

In an embodiment, the imposition of trusted operability by the trusted hypervisor may work in the following fashion. For example, a user of a smartphone, whose network provider uses an NFV network, may be using the phone to access bank account information through an application on the phone. In order to access the financial data, the application needs to operate in a trusted manner. The trusted hypervisor assigns the execution of the application to a virtual server allocated to a specific core processing unit on a processor. While the application is executing in trust, a telephone call (an untrusted process) comes in to the user's phone over an untrusted communication network—such as circuit switched or HLR (home location register). In order to permit the user to operate both actions, i.e. operate the financial application and the telephone call simultaneously, the hypervisor then assigns a dedicated cache and memory to the core processing unit executing the trusted application which then allows the untrusted telephone call to execute simultaneously with the trusted application. The dedicated cache and memory prevent the untrusted process from making any incursion into the trusted application to access trusted date.

Further, for example, a smartphone user may be physically located in an area where both long term evolution (LTE) protocol is available and a circuit switched network, and the phone can see both networks at the same time. Certain applications running on the cellphone may execute in a trusted manner on the LTE network but in an untrusted manner on the circuit switched network, therefore the imposition of trusted operability by a hypervisor as disclosed is critical to prevent security incursion by the untrusted application via accessing the same data pool being accessed by the trusted application.

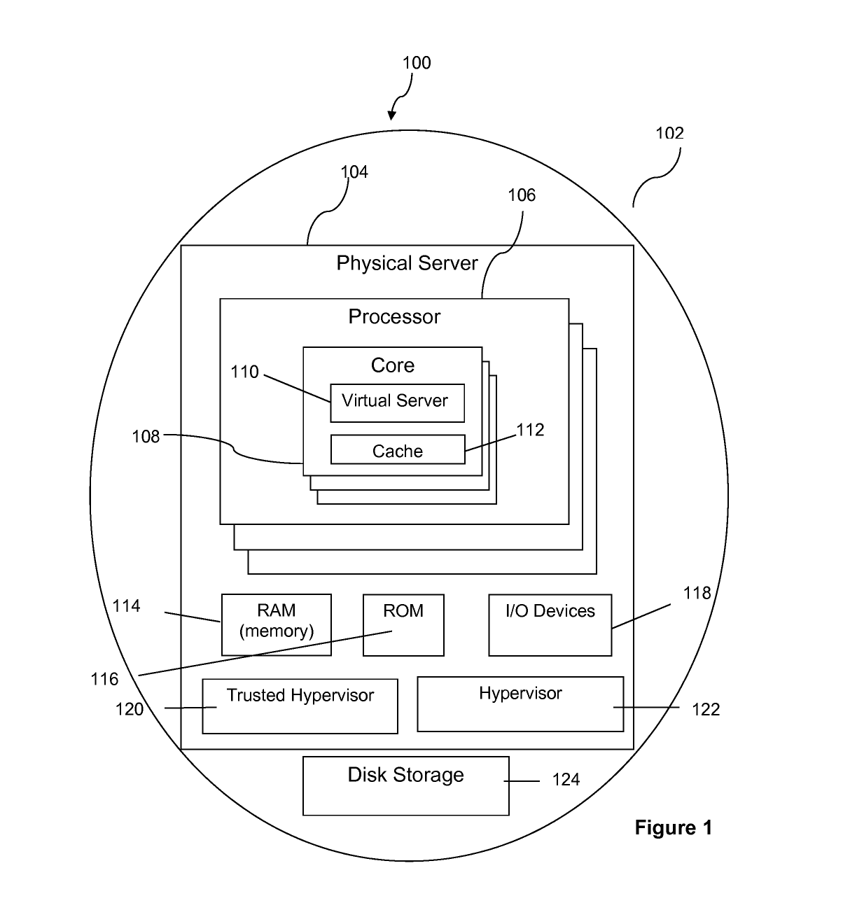

FIG. 1 is an illustration of a system 100 according to embodiments of the present disclosure. In the system 100, the NFV network 102 may comprise at least one physical server 104, which can be any generalized purpose hardware, a blade, a hypervisor, combination of hardware and a hypervisor, or other equipment that can execute in an NFV environment, and at least one unit of disk storage 124. The physical server 104 may comprise at least one processor 106, Random Access Memory (RAM) 114, Read Only Memory (ROM) 116, one or more I/O devices 118, and a trusted hypervisor 120. In an alternative embodiment, the physical server 104 may also comprise a second hypervisor 122. The processor 106 may comprise multiple core processing units 108 capable of executing one or more virtualized functions or processes. Each core processing unit 108 comprises one virtual server 110 and dedicated cache 112.

In an embodiment, the NFV network 102 provides core network services to a radio access network (RAN) that provides communication service to user equipments (UEs), where the RAN supports at least one of a long term evolution (LTE), a code division multiple access (CDMA), a global system for mobile communication (GSM), and a worldwide interoperability for microwave access (WiMAX) wireless communication protocol. The UEs may comprise smart phones, media players, laptop computers, tablet computers, notebook computers, wearable computers, headset computers, and the like. RAN may comprise enhanced node B (eNBs) or base transceiver stations (BTSs) (e.g., ‘cell towers’) that provide wireless communication links to the UEs and wired links to the first NFV network 102. In some circumstances, the RAN may be considered to be trusted because the RAN is un-hackable and secure.

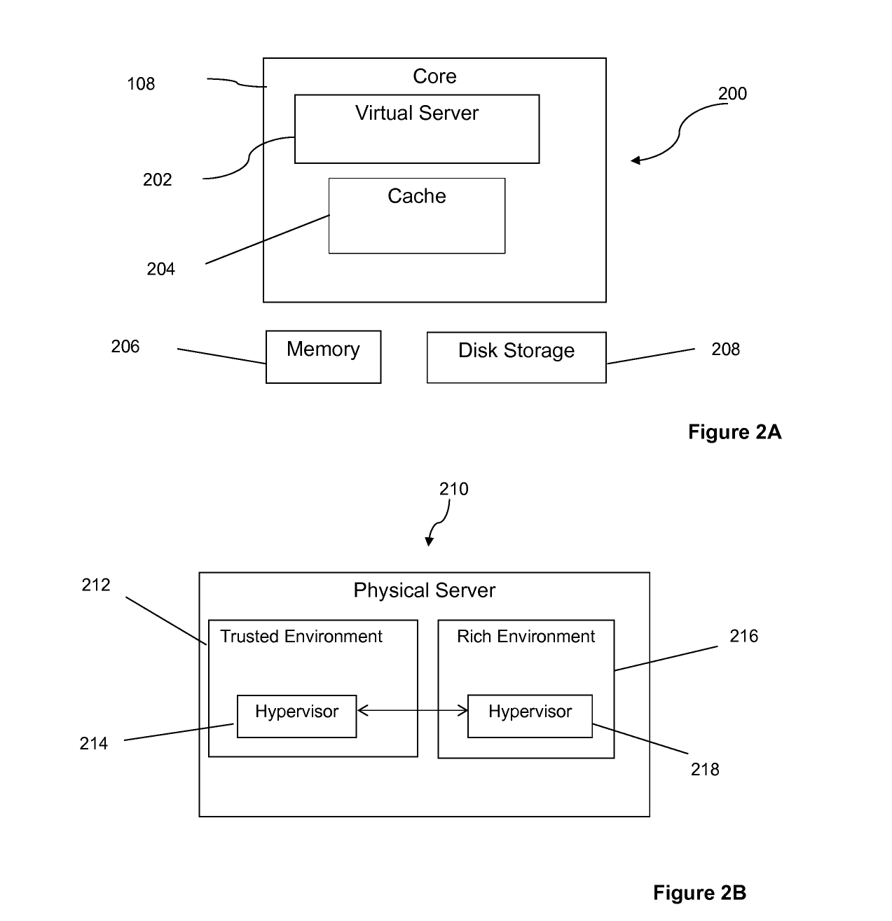

Continuing with FIG. 1, the trusted hypervisor 120 may be dedicated to the physical server 104 and operate as the governing software entity for all processes executing on the server. As such the hypervisor provides trusted operability for virtualized functions that may execute in trust. Alternatively, in an embodiment, and as explained in more detail with reference to FIG. 2B, the physical server 104 may comprise both a trusted hypervisor 120 and an untrusted hypervisor 122, each dedicated to trusted or untrusted processes, respectively, that execute on the physical server 104.

Turning now to FIG. 2A, a core processing unit 200 is disclosed according to an embodiment. The core processing unit 108 may comprise a single virtual server 202 assigned to core processing unit 108 by the trusted hypervisor 120 (not shown in FIG. 2A). Trusted or untrusted processes may execute on virtual server 202, depending on the determination of the trusted hypervisor 120. If trusted processes are assigned by the trusted hypervisor 120 to execute on core processing unit 108, core processing unit 108 may also comprise a dedicated cache 204. Further, in order to execute the trusted processes assigned to core processing unit 108 with trusted operability, the trusted hypervisor 120 may also dedicate a portion of memory, dedicated memory 206 and dedicated disk storage 208, to the core processing unit 108. When the core processing unit 108 executes a trusted process, dedicated cache 204, dedicated memory 206, and dedicated disk storage 208 are inaccessible to any other process other than the trusted process executing on core processing unit 108.

FIG. 2B discloses, according to an alternative embodiment, a physical server 210 which may comprise two dedicated hypervisors to manage virtualized functions executing on the processors of physical server 210. Physical server 210 may comprise a trusted hypervisor 214 that operates as the governing software entity for all trusted processes executing on the physical server 210 in the trusted environment 212. Trusted hypervisor 214 would operate in the same manner as described in FIGS. 1 and 2A. Hypervisor 218, which may or may not be trusted, operates as the governing software entity for all untrusted processes executing on the server in the rich environment 216. Because hypervisor 218 does not impose trusted operability onto core processing units executing untrusted processes, no portion of cache, memory, or disk storage is allocated to these core processing units by hypervisor 218.

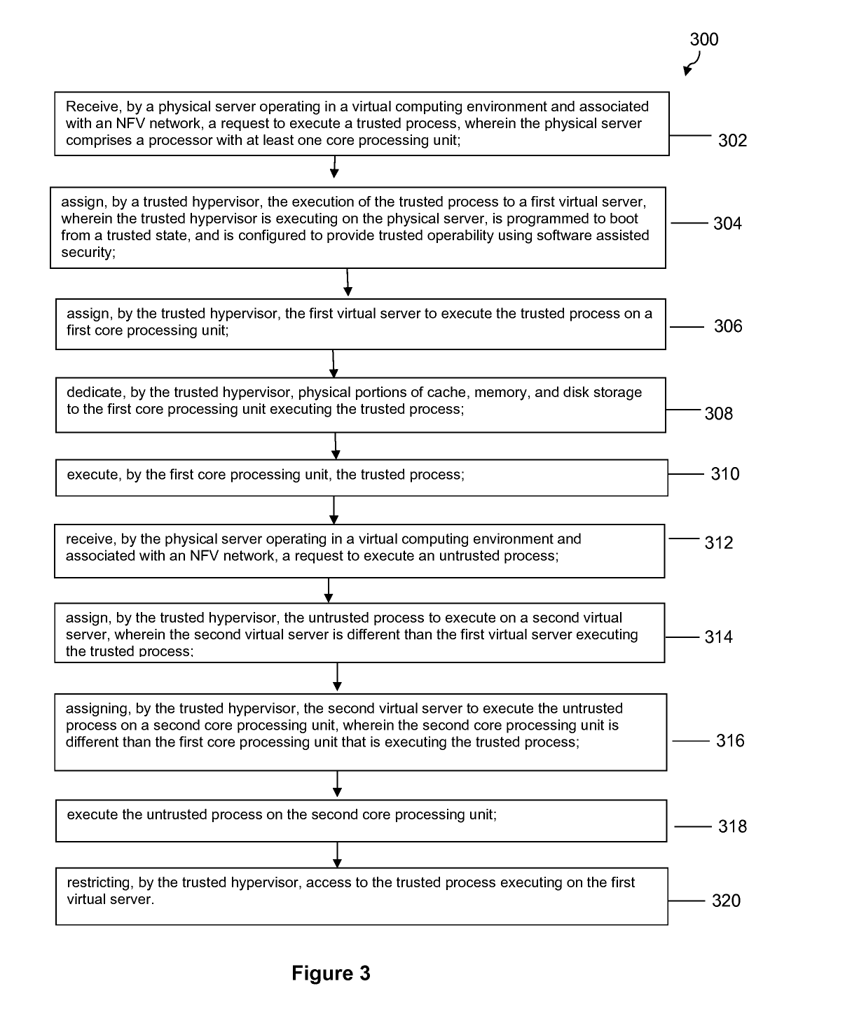

FIG. 3 depicts a method 300 of establishing trusted operability between virtualized states of a Network Functions Virtualization (NFV) system providing a network service and operating in a virtual computing environment, according to an embodiment of the disclosure. At block 302, a server 104 receives a request to execute a trusted process. At block 304, hypervisor 120 assigns the execution of a trusted process to a first virtual server 202. At block 306, hypervisor 120 assigns the first virtual server 202 to execute the trusted process on a first core processing unit 108. At block 308, the trusted hypervisor 120 dedicates physical portions of cache 204, memory 206, and disk storage 208 to the first core processing unit 108. At block 310, the core processing unit 108 executes the trusted process. At block 312, server 104 receives a new request to execute an untrusted process. At block 314, hypervisor 120 assigns the untrusted process to execute on a second virtual server 202, wherein the second virtual server 202 is different than the first virtual server 202 that is executing the trusted process. At block 316, hypervisor 120 assigns the second virtual server 202 to execute the untrusted process on a different core processing unit 108 other than the core processing unit 108 that is executing the trusted process. At block 318, the core processing unit 108 assigned to the untrusted process executes the untrusted process. At block 320, the trusted hypervisor restricts access to the trusted process executing on the first virtual server 202.

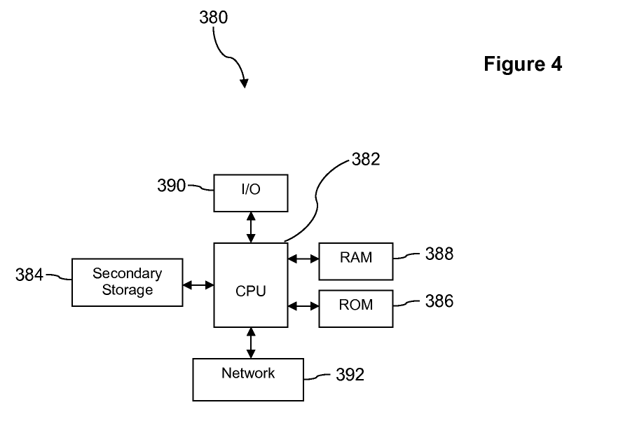

FIG. 4 illustrates a computer system 380 suitable for implementing one or more embodiments disclosed herein. The computer system 380 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 380, at least one of the CPU 382, the RAM 388, and the ROM 386 are changed, transforming the computer system 380 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 380 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 380 to provide the functionality of a number of servers that is not directly bound to the number of computers in the computer system 380. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 380, at least portions of the contents of the computer program product to the secondary storage 384, to the ROM 386, to the RAM 388, and/or to other non-volatile memory and volatile memory of the computer system 380. The processor 382 may process the executable instructions and/or data structures in part by directly accessing the computer program product, for example by reading from a CD-ROM disk inserted into a disk drive peripheral of the computer system 380. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 380 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method of establishing trusted operability between virtualized states of a Network Functions Virtualization (NFV) system providing a network service and operating in a virtual computing environment, comprising:
receiving, by a physical server operating in a virtual computing environment and associated with an NFV network, a request to execute a trusted process, wherein the physical server comprises a processor with at least one core processing unit;
assigning, by a trusted hypervisor, the execution of the trusted process to a first virtual server, wherein the trusted hypervisor is executing on the physical server, is programmed to boot from a trusted state, and is configured to provide trusted operability using software assisted security;
assigning, by the trusted hypervisor, the first virtual server to execute the trusted process on a first core processing unit;
dedicating, by the trusted hypervisor, physical portions of cache, memory, and disk storage to the first core processing unit executing the trusted process;
executing, by the first core processing unit, the trusted process;
receiving, by the physical server operating in a virtual computing environment and associated with an NFV network, a request to execute an untrusted process;
assigning, by the trusted hypervisor, the untrusted process to execute on a second virtual server, wherein the second virtual server is different than the first virtual server executing the trusted process;
assigning, by the trusted hypervisor, the second virtual server to execute the untrusted process on a second core processing unit, wherein the second core processing unit is different than the first core processing unit that is executing the trusted process;
executing the untrusted process on the second core processing unit; and
restricting, by the trusted hypervisor, access to the trusted process executing on the first virtual server.

2. The method of claim 1, wherein the untrusted process is assigned to the second core processing unit by a second hypervisor that does not provide trusted operability.

3. The method of claim 1, wherein the second hypervisor is configured to exclusively monitor the untrusted processes executing on the processor.

4. The method of claim 1, wherein the trusted hypervisor restricts access to the first virtual server, the first core processing unit, and to the cache, memory, and disk storage dedicated to the first core processing unit, to only the trusted process.

5. The method of claim 1, wherein the dedicated cache, dedicated RAM memory, and dedicated disk storage, contain memory registers that are associated with an NFV state.

6. The method of claim 1, wherein the NFV network provides core network services to a radio access network (RAN) that provides communication service to user equipment (UE), where the RAN supports at least one of a long term evolution (LTE), a code division multiple access (CDMA), a global system for mobile communication (GSM), and a worldwide interoperability for microwave access (WiMAX) wireless communication protocol.

7. A system for establishing trusted operability between virtualized states of a Network Functions Virtualization (NFV) system providing a network service and operating in a virtual computing environment, comprising:
a physical server operating in a virtual computing environment and associated with an NFV network;
a processor located on the physical server, comprising at least one core processing unit, wherein the processor is configured to execute a trusted process on a dedicated core processing unit;
a cache dedicated to the core processing unit;
a memory dedicated to the core processing unit;
a disk storage dedicated to the core processing unit; and
a trusted hypervisor, executing on the physical server, wherein the trusted hypervisor is programmed to boot from a trusted state, is configured to provide trusted operability using software assisted security, is configured to assign trusted processes to a dedicated core processing unit, and wherein the trusted hypervisor is configured to monitor and restrict software and hardware access to the trusted processes executing on the dedicated core processing unit.

8. The system of claim 7, wherein the NFV network comprises one of the following group: a NFV network, a compute network, a data network, a server, or other computer system in communication with a network operating in an NFV system.

9. The system of claim 7, wherein the trusted hypervisor is configured to restrict access to the dedicated core processing unit, the dedicated cache, the dedicated memory, and the dedicated disk storage, to the trusted process.

10. The system of claim 7, wherein the dedicated cache, dedicated RAM memory, and dedicated disk storage, contain memory registers that are associated with an NFV state.

11. The system of claim 7, wherein the trusted hypervisor is configured to assign a single virtual server to a dedicated core processing unit executing trusted processes.

12. The system of claim 7, wherein the processor is further configured to execute untrusted processes on core processing units separate from the dedicated core processing unit executing trusted processes.

13. The system of claim 7, wherein the NFV network provides core network services to a radio access network (RAN) that provides communication service to user equipment (UE), where the RAN supports at least one of a long term evolution (LTE), a code division multiple access (CDMA), a global system for mobile communication (GSM), and a worldwide interoperability for microwave access (WiMAX) wireless communication protocol.

14. A system for establishing trusted operability between virtualized states of a Network Functions Virtualization (NFV) system providing a network service and operating in a virtual computing environment, comprising:
a physical server operating in a virtual computing environment and associated with an NFV network;
a processor located on the physical server, comprising one or more core processing units, wherein the processor is configured to execute a trusted process on a dedicated core processing unit;
a cache dedicated to the core processing unit;
a memory dedicated to the core processing unit; and
a disk storage dedicated to the core processing unit;
a trusted hypervisor, executing on the physical server, wherein the trusted hypervisor is programmed to boot from a trusted state, is configured to provide trusted operability using software assisted security, is configured to assign trusted processes to a dedicated core processing unit, and wherein the trusted hypervisor is configured to monitor and restrict software and hardware access to the trusted processes executing on the dedicated core processing unit; and
a second hypervisor, executing on the physical server, wherein the second hypervisor does not provide trusted operability;

15. The system of claim 14, wherein the NFV network comprises one of the following group: a NFV network, a compute network, a data network, a server, or other computer system in communication with a network operating in an NFV system.

16. The system of claim 14, wherein the trusted hypervisor is configured to restrict access to the dedicated core processing unit, the dedicated cache, the dedicated memory, and the dedicated disk storage, to the trusted process.

17. The system of claim 14, wherein the processor is further configured to execute untrusted processes on core processing units separate from the dedicated core processing unit executing trusted processes.

18. The system of claim 14, wherein the second hypervisor is configured to exclusively monitor the untrusted processes executing on the processor.

19. The system of claim 14, wherein the dedicated cache, dedicated RAM memory, and dedicated disk storage, contain memory registers that are associated with an NFV state.

20. The system of claim 14, wherein the NFV network provides core network services to a radio access network (RAN) that provides communication service to user equipment (UE), where the RAN supports at least one of a long term evolution (LTE), a code division multiple access (CDMA), a global system for mobile communication (GSM), and a worldwide interoperability for microwave access (WiMAX) wireless communication protocol.
